(19) United States
(12) Patent Application Publication
(10) Pub. No.: US 2026/0214645 A1
(43) Pub. Date: Jul. 23, 2026

(54) METHOD AND APPARATUS FOR AGC SYMBOL DETERMINATION IN A SIDELINK UNLICENSED SPECTRUM

(71) Applicant: LENOVO (BEIJING) LIMITED, Beijing (CN)

(72) Inventors: Xiaodong YU, Beijing (CN); Haipeng LEI, Beijing (CN); Zhennian SUN, Beijing (CN); Xin GUO, Beijing (CN)

(21) Appl. No.: 19/138,888

(22) PCT Filed: Dec. 16, 2022
(86) PCT No.: PCT/CN2022/139750

§ 371 Date: Jun. 13, 2025

(51) Int. Cl. H04W 72/044; H04W 72/25

(52) U.S. Cl. CPC H04W 72/044; H04W 72/25

(57) ABSTRACT

Embodiments of the present disclosure relate to methods and apparatuses for automatic gain control (AGC) symbol determination in a sidelink unlicensed spectrum (SL-U). According to some embodiments of the disclosure, a user equipment (UE) may include a transceiver; and a processor coupled to the transceiver. The processor may be configured to cause the UE to: determine whether an additional automatic gain control (AGC) symbol is needed in a time slot based on a transmission frequency resource size of the time slot or indication information indicated, configured or pre-configured; and in response to determining that the additional AGC symbol is needed in the time slot, perform a sidelink (SL) transmission in the time slot including an AGC symbol at a starting symbol of the time slot and one or more additional AGC symbols in the time slot.

### TECHNICAL FIELD

Embodiments of the present disclosure generally relate to wireless communication technology, especially to methods and apparatuses for automatic gain control (AGC) symbol determination in a sidelink unlicensed spectrum (SL-U).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum. An unlicensed spectrum may also be named as an unlicensed band or the like.

Currently, details regarding AGC symbol determination in SL-U have not been discussed yet.

### SUMMARY

Some embodiments of the present disclosure provide a user equipment (UE). The UE may include a transceiver; and a processor coupled to the transceiver. The processor may be configured to cause the UE to: determine whether an additional automatic gain control (AGC) symbol is needed in a time slot based on a transmission frequency resource size of the time slot or indication information indicated, configured or pre-configured; and in response to determining that the additional AGC symbol is needed in the time slot, perform a sidelink (SL) transmission in the time slot including an AGC symbol at a starting symbol of the time slot and one or more additional AGC symbols in the time slot.

In some embodiments, the one or more additional AGC symbols are presented at a set of certain symbols in the time slot after the starting symbol of the time slot.

In some embodiments, the set of certain symbols are configured or pre-configured per a resource pool, per a resource block (RB) set, or per a system bandwidth or are fixed in the time slot.

In some embodiments, to determine whether the additional AGC symbol is needed based on the transmission frequency resource size, the processor is configured to cause the UE to: determine whether the transmission frequency resource size is equal to or greater than a frequency resource threshold; in response to determining that the transmission frequency resource size is equal to or greater than the frequency resource threshold, determine that the additional AGC symbol is not needed in the time slot; and in response to determining that the transmission frequency resource size is less than the frequency resource threshold, determine that the additional AGC symbol is needed in the time slot.

In some embodiments, the frequency resource threshold is configured or pre-configured per a resource pool, per a RB set, or per a system bandwidth or is fixed as a total number of all RB sets within a system bandwidth.

In some embodiments, the transmission frequency resource size is associated with: one or more RB sets within a system bandwidth; or one or more interlaces spanning on all RB sets or partial RB sets within the system bandwidth.

In some embodiments, the processor is configured to cause the UE to transmit a first indication to indicate at least one of the following: the one or more additional AGC symbols are presented or not within the time slot; or a total number of the one or more additional AGC symbols presented within the time slot.

In some embodiments, the processor is configured to cause the UE to transmit a frequency resource indication, and the frequency resource indication includes at least one of a RB set index or an interlace index.

In some embodiments, at least one of the first indication or the frequency resource indication is included in sidelink control information (SCI).

In some embodiments, the first indication is included in a field including one or more bits in the SCI.

In some embodiments, a field in the SCI including the first indication is set to a default value to indicate that the one or more additional AGC symbols are not presented within the time slot.

In some embodiments, in response to determining that the additional AGC symbol is not needed in the time slot, sidelink control information (SCI) transmitted by the UE does not include indication information related to presence of the additional AGC symbol.

In some embodiments, the indication information is received from a higher layer of the UE or a network, and wherein the indication information is configured or pre-configured per a resource pool, per a resource block (RB) set, or per a system bandwidth.

In some embodiments, the indication information is included in a medium access control (MAC) control element (CE) or radio resource control (RRC) signalling.

Some embodiments of the present application also provide a UE. The UE may include a transceiver; and a processor coupled to the transceiver. The processor may be configured to cause the UE to: determine whether an additional automatic gain control (AGC) symbol is needed in a time slot based on indication information received, indicated, configured or pre-configured; and in response to determining that the additional AGC symbol is needed in the time slot, receive a sidelink (SL) transmission in the time slot including an AGC symbol at a starting symbol of the time slot and one or more additional AGC symbols in the time slot.

In some embodiments, the processor is configured to cause the UE to: in response to determining that the additional AGC symbol is needed, monitor the one or more additional AGC symbols; or in response to determining that the additional AGC symbol is not needed, prohibit monitoring the one or more additional AGC symbols.

In some embodiments, the one or more additional AGC symbols are presented at a set of certain symbols in the time slot after the starting symbol of the time slot.

In some embodiments, the set of certain symbols are configured or pre-configured per a resource pool, per a resource block (RB) set, or per a system bandwidth or are fixed in the time slot.

In some embodiments, the processor is configured to cause the UE to receive the indication information in sidelink control information (SCI) from a second UE.

In some embodiments, the indication information is included in a field including one or more bits in the SCI.

In some embodiments, the indication information received from the second UE indicates at least one of the following: the one or more additional AGC symbols are presented or not within the time slot; or a total number of the one or more additional AGC symbols presented within the time slot.

In some embodiments, the indication information is set to a default value to indicate that the one or more additional AGC symbols are not presented within the time slot.

In some embodiments, the processor is configured to cause the UE to: determine whether sidelink control information (SCI) received from a second UE includes the indication information related to presence of the additional AGC symbol; and in response to determining that the SCI does not include the indication information, determine that the one or more additional AGC symbols are not presented in the time slot.

In some embodiments, the indication information is a frequency resource indication including at least one of a RB set index or an interlace index.

In some embodiments, to determine whether the additional AGC symbol is needed or not based on the frequency resource indication, the processor is configured to cause the UE to: determine a transmission frequency resource size used by the second UE based on the frequency resource indication; determine whether the transmission frequency resource size is equal to or greater than a frequency resource threshold; in response to determining that the transmission frequency resource size is equal to or greater than the frequency resource threshold, determine that the additional AGC symbol is not needed in the time slot; and in response to determining that the transmission frequency resource size is less than the frequency resource threshold, determine that the additional AGC symbol is needed in the time slot.

In some embodiments, the frequency resource threshold is configured or pre-configured per a resource pool, per a RB set, or per a system bandwidth or is fixed as a total number of all RB sets within a system bandwidth.

In some embodiments, the transmission frequency resource size is associated with: one or more RB sets within a system bandwidth; or one or more interlaces spanning on all RB sets or partial RB sets within the system bandwidth.

In some embodiments, the processor is configured to cause the UE to receive the indication information from a higher layer of the UE or a network, and wherein the indication information is configured or pre-configured per a resource pool, per a resource block (RB) set, or per a system bandwidth.

In some embodiments, the indication information is included in a medium access control (MAC) control element (CE) or radio resource control (RRC) signalling.

Some embodiments of the present disclosure provide a method performed by a UE. The method may include: determining whether an additional automatic gain control (AGC) symbol is needed in a time slot based on a transmission frequency resource size of the time slot or indication information indicated, configured or pre-configured; and in response to determining that the additional AGC symbol is needed in the time slot, performing a sidelink (SL) transmission in the time slot including an AGC symbol at a starting symbol of the time slot and one or more additional AGC symbols in the time slot.

Some embodiments of the present disclosure provide a method performed by a UE. The method may include: determining whether an additional automatic gain control (AGC) symbol is needed in a time slot based on indication information received, indicated, configured or pre-configured; and in response to determining that the additional AGC symbol is needed in the time slot, receiving a sidelink (SL) transmission in the time slot including an AGC symbol at a starting symbol of the time slot and one or more additional AGC symbols in the time slot.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method performed by a UE according to some embodiments of the present disclosure.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIGS. 2 and 3 illustrate exemplary diagrams of AGC symbols in accordance with some embodiments of the present disclosure.

FIGS. 4 and 5 illustrate exemplary flowcharts related to AGC symbol determination over an unlicensed spectrum in accordance with some embodiments of the present disclosure.

FIGS. 6-10 illustrate exemplary diagrams of AGC symbols in accordance with some embodiments of the present disclosure.

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

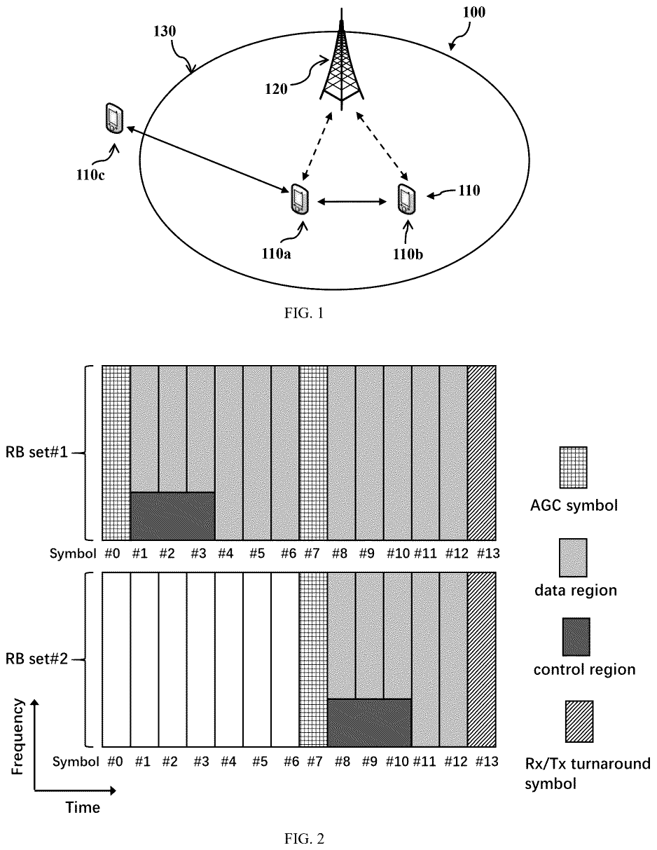

FIG. 1 illustrates a schematic diagram of a wireless communication system in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

Currently, it is agreed that two candidate starting symbols for PSCCH/PSSCH transmission(s) is supported in SL-U with considering the resource efficiency. For PSCCH/PSSCH transmission(s) from the first candidate starting symbol, the first symbol in a slot is used for AGC usage. For PSCCH/PSSCH transmission(s) from the second candidate starting symbol, the second candidate starting symbol can be used for AGC usage.

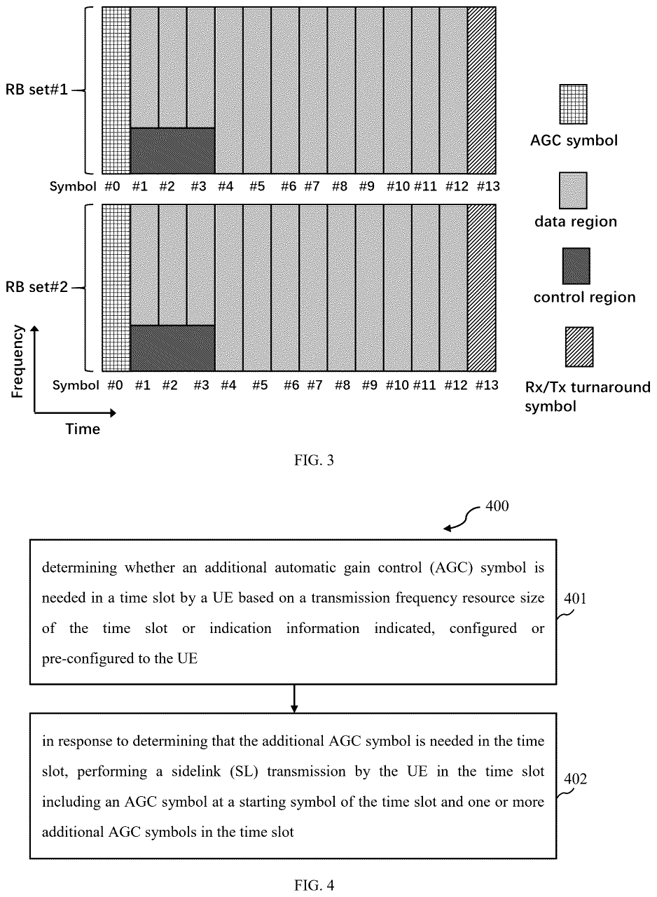

FIGS. 2 and 3 illustrate exemplary diagrams of AGC symbols in accordance with some embodiments of the present disclosure. The embodiments of FIGS. 2 and 3 show two RB set resources in frequency domain (i.e., RB set #1 and RB set #2) within one time slot including 14 symbols (i.e., Symbol #0 to Symbol #13) in time domain. It should be appreciated by persons skilled in the art that the total number of time-frequency resources and locations of data region(s), control region(s), AGC symbol(s), and Rx/Tx turnaround symbol(s) in the time-frequency resources as shown in FIGS. 2 and 3 may be changed, varied, or modified in different embodiments, without departing from the spirit and scope of the disclosure.

The embodiments of FIGS. 2 and 3 assume that two candidate starting symbols for PSCCH/PSSCH transmission, e.g., Symbol #0 and Symbol #7, are supported. Based on results of a listen-before-talk (LBT) procedure, as shown in FIG. 2, if one UE (e.g., Tx UE #1) performs PSCCH/PSSCH transmission(s) in RB set #1 from the first candidate starting symbol (i.e., Symbol #0) and a further UE (e.g., Tx UE #2) performs PSCCH/PSSCH transmission(s) in RB set #2 from the second candidate starting symbol (i.e., Symbol #7), there will be power impact at another UE (e.g., an Rx UE) side in the time slot. To avoid this power impact, the second AGC symbol for Tx UE #1 (i.e., Symbol #7) in RB set #1 is needed.

However, if Tx UE #1 performs PSCCH/PSSCH transmission in both RB set #1 and RB set #2 (i.e., full bandwidth), the second AGC symbol can be used for PSSCH transmission with considering resource efficiency, i.e., the second AGC symbol is not needed. For example, as shown in FIG. 3, Symbol #7 in both RB set #1 and RB set #2 can be used for PSSCH transmission, but not used as the second AGC symbol. If Symbol #7 in both RB set #1 and RB set #2 is still used as the second AGC symbol, the resource efficiency is low.

Given the above, issues of how to assign one or more symbols for AGC purpose, how to indicate such one or more AGC symbols from a Tx UE to an Rx UE, and how to determine which symbol is used for PSSCH transmission or AGC purpose at the Rx UE need to be solved. Embodiments of the present disclosure provide solutions to solve the above issues. For example, some embodiments of the present disclosure define an indication to indicate whether AGC symbol(s) is presented or not. Some embodiments of the present disclosure define a rule for a Tx UE and an Rx UE to transmit or monitor AGC symbol(s) based on a transmission frequency resource size. More details on the embodiments of the present disclosure will be illustrated in the following text in combination with the appended drawings.

FIG. 4 illustrates an exemplary flowchart related to AGC symbol determination over an unlicensed spectrum in accordance with some embodiments of the present disclosure. The exemplary procedure 400 may be performed by a UE, for example, UE 110 in FIG. 1. In some embodiments, the exemplary procedure 400 may be performed by a Tx UE over sidelink. Although described with respect to a UE or a Tx UE, it should be understood that other devices may be configured to perform a method similar to that of FIG. 4.

Referring to the exemplary procedure 400 in FIG. 4, in operation 401, a UE (e.g., UE 110a in FIG. 1) may determine whether an additional AGC symbol is needed in a time slot based on a transmission frequency resource size of the time slot or indication information indicated, configured or pre-configured. In some embodiments, the transmission frequency resource size or the indication information may be used to indicate whether the additional AGC symbol is enabled or disabled in the time slot.

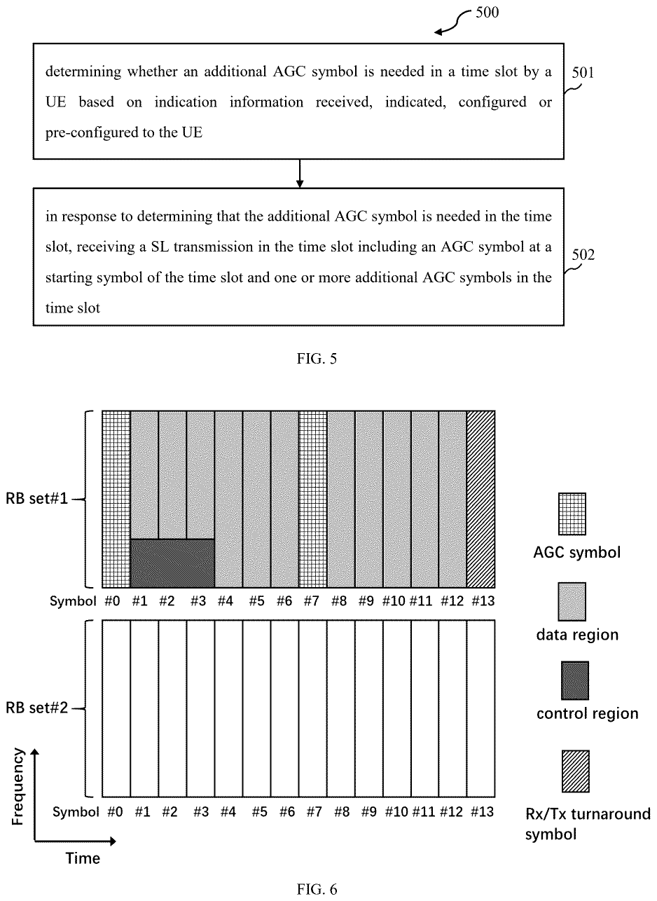

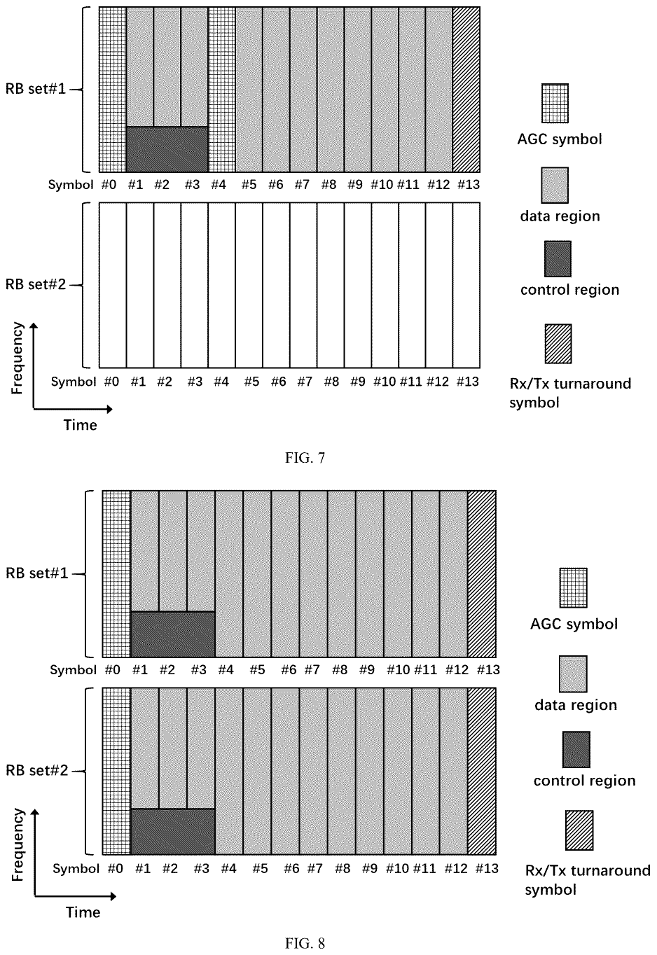

In operation 402, in response to determining that the additional AGC symbol is needed in the time slot, the UE may perform a sidelink (SL) transmission in the time slot including “an AGC symbol at a starting symbol of the time slot” and “one or more additional AGC symbols in the time slot”. The AGC symbol at the starting symbol (e.g., Symbol #0 in FIGS. 2, 3, and 6-10) may be referred to as “the starting AGC symbol”, “the first AGC symbol”, or “the initial AGC symbol” in some cases. The additional AGC symbol is in the middle of the time slot, i.e., it is not the starting/first/initial (AGC) symbol (Symbol #0) of the time slot. For example, the additional AGC symbol can be the 5th symbol (Symbol #4) as shown in FIG. 7 or the 8th symbol (Symbol #7) of the time slot as shown in FIGS. 2 and 6 of the time slot. The additional AGC symbol(s) included in the time slot may also be named as “presented in the time slot”, “existing in the time slot”, or “enabled in the time slot or the like”.

In some embodiments, the one or more additional AGC symbols are presented at a set of certain symbols in the time slot after the starting symbol of the time slot. In an embodiment, the set of certain symbols are configured or pre-configured per a resource pool, per a RB set, or per a system bandwidth. In another embodiment, the set of certain symbols are fixed in the time slot. For example, the set of certain symbols for additional AGC symbols are fixed in Symbol #7 as shown in FIGS. 2 and 6 or in Symbol #4 as shown in FIG. 7.

In particular, in an embodiment, if two candidate starting symbols for PSCCH/PSSCH transmission(s) are supported, e.g., Symbol #0 and Symbol #4, Symbol #0 may be referred to as “the initial candidate starting symbol” or “the first candidate starting symbol”, while Symbol #4 is “the additional candidate starting symbol” which may also be referred to as “the second candidate starting symbol” or the like. In another embodiment, another two candidate starting symbols for PSCCH/PSSCH transmission(s), e.g., Symbol #0 and Symbol #7, may be supported, in which Symbol #7 is “the additional candidate starting symbol”. In some embodiments, any of the additional candidate starting symbols may be used to carry an additional AGC symbol. That is, the set of certain symbols include Symbol #4 and Symbol #7 for additional AGC purpose.

In some embodiments of the exemplary procedure 400, the UE may determine whether the additional AGC symbol is needed based on the transmission frequency resource size of the time slot. In particular, the UE may determine whether the transmission frequency resource size is equal to or greater than a frequency resource threshold. If the transmission frequency resource size is equal to or greater than the frequency resource threshold, e.g., if the UE performs transmission on all RB sets within a system bandwidth, the UE may determine that the additional AGC symbol is not needed in the time slot. If the transmission frequency resource size is less than the frequency resource threshold, e.g., if the UE performs transmission one or more RB sets in all RB sets within the system bandwidth, the UE may determine that the additional AGC symbol is needed in the time slot.

In an embodiment, the frequency resource threshold may be configured or pre-configured per a resource pool, per a RB set, or per a system bandwidth. In another embodiment, the frequency resource threshold is fixed as a total number of all RB sets within the system bandwidth.

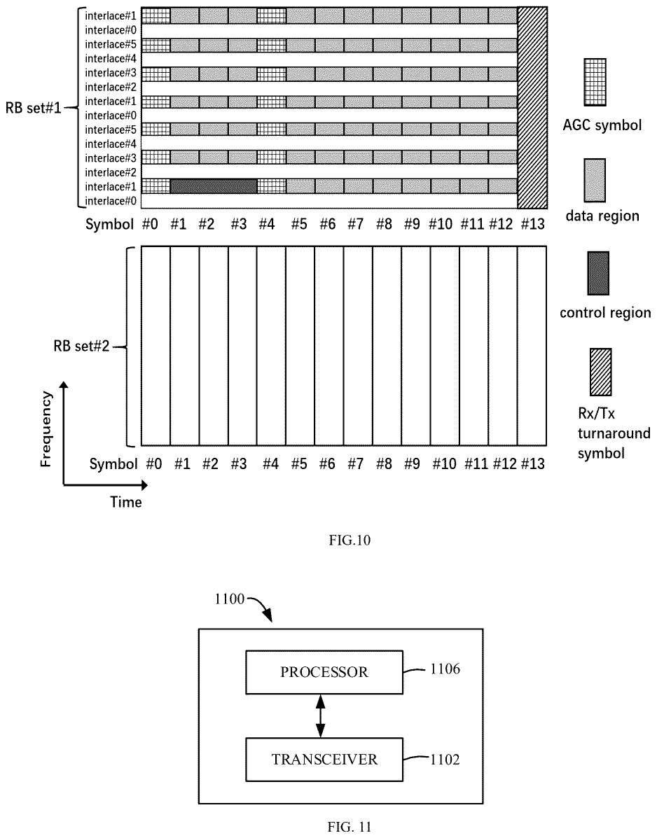

In some embodiments, the transmission frequency resource size is associated with one or more RB sets within the system bandwidth. Specific examples are described in the embodiments of FIGS. 6-8 as follows. In some other embodiments, the transmission frequency resource size is associated with one or more interlaces spanning on all RB sets or partial RB sets within the system bandwidth. Specific examples are described in the embodiments of FIGS. 9 and 10 as follows.

In some embodiments of the exemplary procedure 400, the UE may determine whether the additional AGC symbol is needed based on the indication information which is indicated, configured or pre-configured. The indication information may also be named as “configuration information” or the like. In an embodiment, the indication information may be indicated by a higher layer of the UE. In another embodiment, the indication information may be configured or pre-configured by a network to the UE. The indication information may be included in a MAC CE or RRC signalling. The indication information may be configured or pre-configured per a resource pool, per a RB set, or per a system bandwidth. In particular, the UE may determine that PSCCH/PSSCH transmission has one or more symbols (e.g., two symbols) for AGC purpose based on the indication information. For instance, the UE may determine that the additional AGC symbol is needed in the time slot based on the indication information and may determine locations of additional AGC symbol(s) in the time slot based on the indication information.

In some embodiments of the exemplary procedure 400, the UE may transmit an indication (denoted as indication #1 for simplicity), e.g., after determining that the additional AGC symbol is needed or not in the time slot, to indicate at least one of the following:
(1) one or more additional AGC symbols are presented or not within the time slot; or
(2) a total number of the one or more additional AGC symbols presented within the time slot.

Indication #1 may be transmitted to a further UE (for example, an Rx UE, e.g., UE 110b in FIG. 1). In some embodiments, indication #1 may be included in SCI, e.g., the SCI is transmitted in control region in any of FIGS. 2, 3, and 6-10. For instance, indication #1 is included in a field including one or more bits in the SCI. The field in the SCI may be in a bitmap manner, to indicate that the additional AGC symbol(s) is presented or not or to indicate a total number of additional AGC symbol(s) presented within the time slot. In an embodiment, the field in the SCI including indication #1 is set to a default value, to indicate that the one or more additional AGC symbols are not presented within the time slot.

In particular, the field in the SCI may be 1 bit. For instance, ‘1’ of this bit represents that the additional AGC symbol is presented or existing in the time slot, while ‘0’ of this bit represents that the additional AGC symbol is not presented or existing in the time slot. When the additional candidate starting symbol is not for AGC purpose, it may be used for PSSCH transmission(s), e.g., which is transmitted in data region in any of FIGS. 2, 3, and 6-10.

The field in the SCI may be two or more bits. For instance, 2 bits of this field may represent that at most 4 candidate starting symbols in the time slot may be not for AGC purpose, 3 bits of this field may represent that at most 8 candidate starting symbols in the time slot may be not for AGC purpose, and so on.

More specifically, in an embodiment, indication #1 may be transmitted in the SCI after the first candidate starting symbol (e.g., Symbol #0) in a time slot of a COT initiated by the UE (i.e., the Tx UE), to indicate the presence of additional AGC symbol(s) in the same time slot. For instance, as shown in RB set #1 in FIGS. 6-10, the SCI transmitted in Symbol #1 to Symbol #3 after Symbol #0 may carry indication #1. In this embodiment, an Rx UE may check indication #1 to determine the presence of the additional AGC symbol(s) in the same time slot.

In another embodiment, if the SCI is transmitted from the second candidate starting symbol (e.g., Symbol #7 in RB set #1 in FIG. 2) in the time slot of the COT initiated by the UE, the SCI does not need to indicate the presence of additional AGC symbol(s) in the same slot. For example, indication #1 in the SCI may be set to a default value, e.g., 0 or 1. Or, indication #1 may be not included in the SCI. In some embodiments, an Rx UE may ignore indication #1 in the SCI, if the Rx UE detects that the PSCCH/PSSCH transmission is starting from the additional candidate starting symbol.

In some other embodiments, in response to determining that the additional AGC symbol is not needed in the time slot, the SCI transmitted by the UE does not include indication information related to the presence of the additional AGC symbol (e.g., indication #1).

In some embodiments, the UE may transmit a frequency resource indication (denoted as indication #2 for simplicity), which includes a RB set index and/or an interlace index. Indication #2 may be included in SCI or other information in the PSCCH/PSSCH transmission(s) of the UE. For instance, both of indication #1 and indication #2 are included in the SCI. In some embodiments, an Rx UE may receive indication #2 in PSCCH/PSSCH transmission, and may determine whether additional AGC symbol(s) is presented in a time slot or not based on the received indication #2. Specific examples are described in the embodiments of FIGS. 6-10 as follows.

FIG. 5 illustrates another exemplary flowchart related to AGC symbol determination over an unlicensed spectrum in accordance with some embodiments of the present disclosure. The exemplary procedure 500 may be performed by a UE, for example, UE 110 in FIG. 1. In some embodiments, the exemplary procedure 500 may be performed by an Rx UE over sidelink. Although described with respect to a UE or an Rx UE, it should be understood that other devices may be configured to perform a method similar to that of FIG. 5.

Referring to the exemplary procedure 500 in FIG. 5, in operation 501, a UE (e.g., UE 110b in FIG. 1) may determine whether an additional AGC symbol is needed in a time slot based on indication information received, indicated, configured or pre-configured.

In operation 502, in response to determining that the additional AGC symbol is needed in the time slot, the UE may receive a SL transmission in the time slot including an AGC symbol at a starting symbol of the time slot (i.e., the initial candidate starting symbol) and one or more additional AGC symbols in the time slot.

In some embodiments, if the UE determines that the additional AGC symbol is needed, the UE may monitor the one or more additional AGC symbols. If the UE determines that the additional AGC symbol is not needed, the UE may prohibit monitoring the one or more additional AGC symbols.

In some embodiments, the one or more additional AGC symbols are presented at a set of certain symbols in the time slot after the starting symbol of the time slot. In an embodiment, the set of certain symbols are configured or pre-configured per a resource pool, per a RB set, or per a system bandwidth. In another embodiment, the set of certain symbols are fixed in the time slot, e.g., Symbol #7 as shown in FIGS. 2 and 6 or in Symbol #4 as shown in FIG. 7.

In some embodiments, the UE may receive the indication information in SCI (e.g., indication #1 as described in the embodiments of FIG. 4) from a further UE (for example, a Tx UE, e.g., UE 110a in FIG. 1). For instance, the indication information is included in a field including one or more bits in the SCI, e.g., the SCI is transmitted in control region in any of FIGS. 2, 3, and 6-10. The indication information received from the further UE may indicate at least one of the following:
(1) one or more additional AGC symbols are presented or not within the time slot; or
(2) a total number of the one or more additional AGC symbols presented within the time slot.

In some embodiments, the indication information (e.g., indication #1 as described in the embodiments of FIG. 4) is set to a default value (e.g., 0 or 1) to indicate that the one or more additional AGC symbols are not presented within the time slot.

In some embodiments, the UE may determine whether the SCI received from another UE (e.g., a Tx UE) includes the indication information related to presence of the additional AGC symbol. If the SCI does not include the indication information, the UE may determine that the one or more additional AGC symbols are not presented in the time slot.

In some embodiments, the indication information is a frequency resource indication (e.g., indication #2 as described in the embodiments of FIG. 4) including at least one of a RB set index or an interlace index. The frequency resource indication may be included in SCI or other information in the PSCCH/PSSCH transmission(s) of the UE.

In some embodiments of the exemplary procedure 500, the UE may determine whether the additional AGC symbol is needed or not based on the frequency resource indication. In particular, the UE may determine a transmission frequency resource size used by the further UE based on the frequency resource indication, and determine whether the transmission frequency resource size is equal to or greater than a frequency resource threshold. If the transmission frequency resource size is equal to or greater than the frequency resource threshold, the UE may determine that the additional AGC symbol is not needed in the time slot. If the transmission frequency resource size is less than the frequency resource threshold, the UE may determine that the additional AGC symbol is needed in the time slot.

In an embodiment, the frequency resource threshold is configured or pre-configured per a resource pool, per a RB set, or per a system bandwidth. In another embodiment, the frequency resource threshold is fixed as a total number of all RB sets within a system bandwidth.

In some embodiments, the transmission frequency resource size is associated with one or more RB sets within a system bandwidth. Specific examples are described in the embodiments of FIGS. 6-8 as follows. In some other embodiments, the transmission frequency resource size is associated with one or more interlaces spanning on all RB sets or partial RB sets within the system bandwidth. Specific examples are described in the embodiments of FIGS. 9 and 10 as follows.

In some embodiments, the UE may receive the indication information from a higher layer of the UE or a network. In an embodiment, the indication information is indicated by a higher layer of the UE. In another embodiment, the indication information is configured or pre-configured by the network to the UE. The indication information may also be named as “configuration information” or the like and may be configured or pre-configured per a resource pool, per a RB set, or per a system bandwidth. For instance, the indication information is included in a MAC CE or RRC signalling.

Details described in all of the foregoing embodiments of the present disclosure are applicable for the embodiments shown in FIG. 4 or FIG. 5. It should be appreciated by persons skilled in the art that the sequence of the operations in the exemplary procedure 400 as shown in FIG. 4 or the exemplary procedure 500 as shown in FIG. 5 may be changed and some of the operations in the exemplary procedure 400 or 500 may be eliminated or modified, without departing from the spirit and scope of the disclosure.

The following texts describe specific embodiments of the exemplary procedure 400 in FIG. 4 or the exemplary procedure 500 in FIG. 5 performed by a UE, i.e., in FIGS. 6-10. Details described in all other embodiments of the present application are applicable for the embodiments of any of FIGS. 6-10. Moreover, details described in the embodiments of any of FIGS. 6-10 are applicable for all the embodiments of FIGS. 1-4.

FIGS. 6-8 illustrate exemplary diagrams of AGC symbols in accordance with some embodiments of the present disclosure. The configurations of time-frequency resources and locations of data region(s), control region(s), AGC symbol(s), and Rx/Tx turnaround symbol(s) in the time-frequency resources in the embodiments of FIGS. 6-8 are similar to those in FIGS. 2 and 3.

In some embodiments, a Tx UE may determine whether additional AGC symbol(s) is needed in a time slot based on its transmission frequency resource. In an embodiment, if the Tx UE performs transmission on a certain frequency resource which is less than a frequency resource threshold, e.g., the Tx UE performs transmission(s) on one or more RB sets of all RB sets within the system bandwidth, the Tx UE may determine that additional AGC symbol(s) is needed in the time slot. Else if the Tx UE performs transmission(s) on a certain frequency resource which is equal to or greater than a frequency resource threshold, e.g., the Tx UE performs transmission(s) on all RB sets within the system bandwidth, the UE may determine that additional AGC symbol(s) is not needed in the time slot. The frequency resource threshold may be configured or pre-configured (e.g., per a resource pool, per a RB set, or per system bandwidth) or be fixed to all RB sets within the system bandwidth.

For example, as shown in the embodiments of FIGS. 6 and 7, if there are two RB sets within the system bandwidth, i.e., RB set #1 and RB set #2, and if a Tx UE performs transmission(s) on only RB set #1 (i.e., there is no data region in RB set #2 as shown in FIGS. 6 and 7), the Tx UE may determine that additional AGC symbol(s) is needed in the time slot. For instance, an additional AGC symbol can be presented in Symbol #7 as shown in FIG. 6 or Symbol #4 as shown in FIG. 6. Then, the Tx UE may transmit indication #1 and/or indication #2 as described in the embodiments of FIG. 4 to indicate that additional AGC symbol(s) is presented within the time slot or indicate a total number of the one or more additional AGC symbols presented within the time slot.

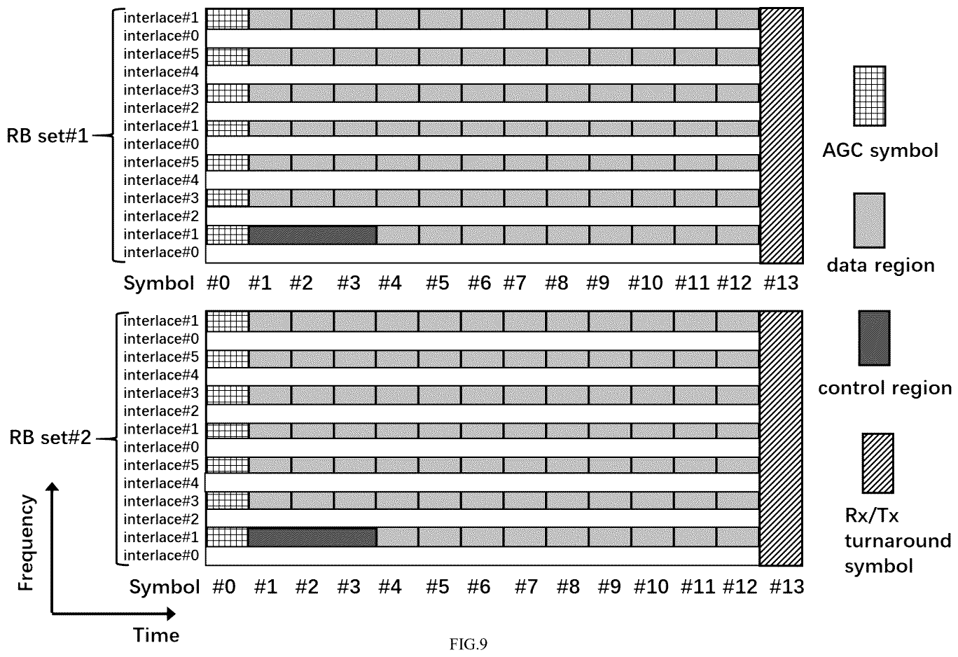

As shown in the embodiments of FIG. 8, if there are two RB sets within the system bandwidth, i.e., RB set #1 and RB set #2, and if a Tx UE performs transmission(s) on both of these two RB sets, the Tx UE may determine that additional AGC symbol(s) is not needed in the time slot. For instance, RB set #1 and RB set #2 only include the initial AGC symbols on Symbol #0, but do not include any additional AGC symbol after Symbol #0. Then, the Tx UE may transmit indication information (e.g., indication #1 and/or indication #2 as described in the embodiments of FIG. 4) to indicate that additional AGC symbol(s) is not presented within the time slot or indicate that a total number of additional AGC symbol(s) presented within the time slot is zero. Or, the Tx UE may not transmit indication information related to presence of the additional AGC symbol, to implicitly indicate that additional AGC symbol(s) is not presented within the time slot.

In the embodiments of FIGS. 6-8, an Rx UE's behavior may be as follows, e.g., if the Tx UE transmits a frequency resource indication, which includes a RB set index and/or an interlace index, to the Rx UE. If the Rx UE detects transmission(s) on a certain frequency resource which is less than a frequency resource threshold, for example, the transmission on one or more RB sets of all RB sets within the system bandwidth (e.g., as shown in FIGS. 6 and 7), the Rx UE may determine that additional AGC symbol(s) is needed or presented in a time slot. Else if the Rx UE detects the transmission(s) on a certain frequency resource which is equal to or greater than the frequency resource threshold, for example, the transmission on all RB sets within system bandwidth (e.g., as shown in FIG. 8), the Rx UE may determine that additional AGC symbol(s) is not needed or presented in a time slot. For instance, the frequency resource threshold may be configured or pre-configured (e.g., per a resource pool, per a RB set, or per system bandwidth) or be fixed to all RB sets within the system bandwidth (e.g., two RB sets in the embodiments of FIGS. 6-8).

FIGS. 9 and 10 illustrate exemplary diagrams of AGC symbols in accordance with some embodiments of the present disclosure. The configurations of time-frequency resources and locations of data region(s), control region(s), AGC symbol(s), and Rx/Tx turnaround symbol(s) in the time-frequency resources in the embodiments of FIGS. 9 and 10 are similar to those in FIGS. 2, 3, and 6-8.

Different from FIGS. 2, 3, and 6-8, in the embodiments of FIGS. 9 and 10, a Tx UE may preform transmission(s) on interlace(s) spanning on RB set(s) within a system bandwidth. For example, as shown in FIGS. 9 and 10, each of RB set #1 and RB set #2 may include multiple interlaces, e.g., interlace #0 to interlace #5, wherein interlace #1, interlace #3, and interlace #5 are used for transmission(s), while interlace #0, interlace #2, and interlace #4 are not used for transmission(s).

In the embodiments of FIG. 9, if the Tx UE preforms transmission(s) on one or more interlace(s) spanning on all RB sets within the system bandwidth, the Tx UE may determine that additional AGC symbol(s) is not needed in the time slot. Then, the Tx UE may transmit indication information (e.g., indication #1 and/or indication #2 as described in the embodiments of FIG. 4) to indicate that additional AGC symbol(s) is not presented within the time slot or indicate that a total number of additional AGC symbol(s) presented within the time slot is zero. Or, the Tx UE may not transmit indication information related to presence of the additional AGC symbol, to implicitly indicate that additional AGC symbol(s) is not presented within the time slot.

In the embodiments of FIG. 10, if a Tx UE performs transmission(s) on one or more interlace(s) spanning on a part (e.g., only RB set #1) of all RB sets within the system bandwidth, the Tx UE may determine that additional AGC symbol(s) is needed in the time slot (e.g., Symbol #4). Then, the Tx UE may transmit indication information (e.g., indication #1 and/or indication #2 as described in the embodiments of FIG. 4) to indicate that additional AGC symbol(s) is presented within the time slot or indicate a total number of additional AGC symbol(s) presented within the time slot (e.g., 1, which represents the only one additional AGC symbol is presented).

In some embodiments of FIGS. 9 and 10, an Rx UE's behavior may be as follows. If an Rx UE receives a frequency resource indication (e.g., indication #2 as described in the embodiments of FIG. 4) in PSCCH/PSSCH transmission(s), the Rx UE may detect data transmission(s) or determine whether additional AGC symbol(s) is needed or presented in a time slot based on the frequency resource indication. If the Rx UE detects transmission(s) on one or more interlace(s) spanning on all RB sets within the system bandwidth, the Rx UE may determine that additional AGC symbol(s) is not needed or not presented in a time slot (e.g., as shown in FIG. 9). Else if the Rx UE detects transmission(s) on one or more interlace(s) spanning on a part of RB sets within the system bandwidth, the Rx UE may determine that additional AGC symbol(s) is needed or presented in a time slot (e.g., as shown in FIG. 10).

FIG. 11 illustrates a block diagram of an exemplary apparatus 1100 in accordance with some embodiments of the present application. As shown in FIG. 11, the apparatus 1100 may include at least one processor 1106 and at least one transceiver 1102 coupled to the processor 1106. Although in this figure, elements such as the at least one transceiver 1102 and processor 1106 are described in the singular, the plural is contemplated unless a limitation to the singular is explicitly stated. In some embodiments of the subject application, the transceiver 1102 may be divided into two devices, such as a receiving circuitry and a transmitting circuitry. In some embodiments of the subject application, the apparatus 1100 may further include an input device, a memory, and/or other components.

In some embodiments of the subject application, the apparatus 1100 may be a UE or a network node (e.g., a BS). The transceiver 1102 and the processor 1106 may interact with each other so as to perform the operations with respect to the UE or the network node described above, for example, in any of FIGS. 1-10.

In some embodiments of the subject application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to a UE or a network node (e.g., a BS) as described above. For example, the computer-executable instructions, when executed, cause the processor 1106 interacting with transceiver 1102 to perform the operations with respect to the UE or the network node described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
least one processor coupled with the at least one memory and configured to cause the UE to:
determine whether an additional automatic gain control (AGC) symbol is needed in a time slot based on a transmission frequency resource size of the time slot or indication information that is indicated, configured, or pre-configured; and
in response to determining that the additional AGC symbol is needed in the time slot, perform a sidelink (SL) transmission in the time slot, including an AGC symbol at a starting symbol of the time slot and one or more additional AGC symbols in the time slot.

2. The UE of claim 1, wherein the one or more additional AGC symbols are presented at a set of certain symbols in the time slot after the starting symbol of the time slot.

3. The UE of claim 2, wherein the set of certain symbols are configured or pre-configured per a resource pool, per a resource block (RB) set, or per a system bandwidth, or are fixed in the time slot.

4. The UE of claim 1, wherein, to determine whether the additional AGC symbol is needed based on the transmission frequency resource size, the at least one processor is configured to cause the UE to:
determine whether the transmission frequency resource size is equal to or greater than a frequency resource threshold;
in response to determining that the transmission frequency resource size is equal to or greater than the frequency resource threshold, determine that the additional AGC symbol is not needed in the time slot; and
in response to determining that the transmission frequency resource size is less than the frequency resource threshold, determine that the additional AGC symbol is needed in the time slot.

5. The UE of claim 4, wherein the frequency resource threshold is configured or pre-configured per a resource pool, per a resource (RB) set, or per a system bandwidth, or is fixed as a total number of all RB sets within a system bandwidth.

6. The UE of claim 4, wherein the transmission frequency resource size is associated with:
one or more resource block (RB) sets within a system bandwidth; or
one or more interlaces spanning on all RB sets or partial RB sets within the system bandwidth.

7. The UE of claim 1, wherein the at least one processor is further configured to cause the UE to transmit a first indication to indicate:
the one or more additional AGC symbols are presented or not within the time slot; or
a total number of the one or more additional AGC symbols presented within the time slot.

8. The UE of claim 1, wherein the at least one processor is further configured to cause the UE to transmit a frequency resource indication, wherein the frequency resource indication includes at least one of a resource block (RB) set index or an interlace index.

9. The UE of claim 8, wherein at least one of the first indication or the frequency resource indication is included in sidelink control information (SCI).

10. The UE of claim 9, wherein the first indication is included in a field including one or more bits in the SCI.

11. The UE of claim 9, wherein a field in the SCI including the first indication is set to a default value to indicate that the one or more additional AGC symbols are not presented within the time slot.

12. The UE of claim 1, wherein, in response to determining that the additional AGC symbol is not needed in the time slot, sidelink control information (SCI) transmitted by the UE does not include indication information related to presence of the additional AGC symbol.

13. The UE of claim 1, wherein the indication information is received from a higher layer of the UE or a network, and wherein the indication information is configured or pre-configured per a resource pool, per a resource block (RB) set, or per a system bandwidth.

14. A user equipment (UE) for wireless communication, comprising:
at least one memory; and
at least one processor coupled with the at least one memory and configured to cause the UE to:
determine whether an additional automatic gain control (AGC) symbol is needed in a time slot based on indication information that is received, indicated, configured, or pre-configured; and
in response to determining that the additional AGC symbol is needed in the time slot, receive a sidelink (SL) transmission in the time slot including an AGC symbol at a starting symbol of the time slot and one or more additional AGC symbols in the time slot.

15. A method performed by a user equipment (UE), the method comprising:
determining whether an additional automatic gain control (AGC) symbol is needed in a time slot based on a transmission frequency resource size of the time slot or indication information that is indicated, configured, or pre-configured; and
in response to determining that the additional AGC symbol is needed in the time slot, performing a sidelink (SL) transmission in the time slot including an AGC symbol at a starting symbol of the time slot and one or more additional AGC symbols in the time slot.

16. The method of claim 15, wherein the one or more additional AGC symbols are presented at a set of certain symbols in the time slot after the starting symbol of the time slot.

17. The method of claim 16, wherein the set of certain symbols are configured or pre-configured per a resource pool, per a resource block (RB) set, or per a system bandwidth, or are fixed in the time slot.

18. The method of claim 15, further comprising:
transmitting a first indication to indicate the one or more additional AGC symbols are presented within the time slot or a total number of the one or more additional AGC symbols presented within the time slot.

19. The method of claim 15, wherein, in response to determining that the additional AGC symbol is not needed in the time slot, sidelink control information (SCI) transmitted by the UE does not include indication information related to presence of the additional AGC symbol.

20. A method performed by a user equipment (UE), the method comprising:
determining whether an additional automatic gain control (AGC) symbol is needed in a time slot based on indication information that is received, indicated, configured, or pre-configured; and
in response to determining that the additional AGC symbol is needed in the time slot, receiving a sidelink (SL) transmission in the time slot including an AGC symbol at a starting symbol of the time slot and one or more additional AGC symbols in the time slot.
